(19) United States
(12) Patent Application Publication
(10) Pub. No.: US 2024/0285136 A1
(43) Pub. Date: Aug. 29, 2024

(54) VACUUM CLEANER ATTACHMENT FOR A SUCTION TUBE OF A VACUUM CLEANER FOR NONDESTRUCTIVELY FILTERING OUT OBJECTS AND/OR LIVING ORGANISMS, COMPRISING AN IMPACT PROTECTION MATERIAL

(71) Applicant: HEADIS GMBH, WESELBERG (DE)

(72) Inventor: RENE WEGNER, WESELBERG (DE)

(73) Assignee: HEADIS GMBH, WESELBERG (DE)

(21) Appl. No.: 18/572,793

(22) PCT Filed: Jul. 1, 2022
(86) PCT No.: PCT/DE2022/200147

§ 371 Date: Dec. 21, 2023

(30) Foreign Application Priority Data
Jul. 2, 2021 (DE) 20 2021 103 572.2

(51) Int. Cl. A47L 9/10; A47L 9/02; A47L 9/12; A47L 9/24; B01D 46/10

(52) U.S. Cl. CPC A47L 9/104; A47L 9/02; A47L 9/122; A47L 9/127; A47L 9/242; B01D 46/10; B01D 2279/55

(57) ABSTRACT

A vacuum attachment for a vacuum tube of a vacuum for a non-destructive screening of an object and/or a living creature. The vacuum attachment includes a suction tube, a collection unit, and an adapter unit. The suction tube has a first end and a second end. The first end is arranged opposite to the second end. A suction opening is arranged at the first end. The collection unit for the non-destructive screening is arranged in the suction tube downstream of the suction opening in a suction direction. The collection unit has at least one opening for a flow of a suction air stream, and an air-permeable impact protection material arranged upstream of the at least one opening in the suction direction. The adapter unit is arranged at the second end of the suction tube. The adapter unit connects to the vacuum tube of the vacuum.

### CROSS REFERENCE TO PRIOR APPLICATIONS

This application is a U.S. National Phase application under 35 U.S.C. § 371 of International Application No. PCT/DE2022/200147, filed on Jul. 1, 2022 and which claims benefit to German Patent Application No. 20 2021 103 572.2, filed on Jul. 2, 2021. The International Application was published in German on Jan. 5, 2023 as WO 2023/274470 A1 under PCT Article 21(2).

### FIELD

The present invention relates to a vacuum attachment for a vacuum tube of a vacuum for the non-destructive screening of objects and/or living creatures, wherein the vacuum attachment has a suction tube with a suction opening at a first end and a collection unit for screening is arranged in the suction tube downstream of the suction opening in a suction direction, wherein the collection unit has one or more openings for the flow of a suction air stream and the vacuum attachment has an adapter unit at a second end which is opposite to the first end for connection to the vacuum tube of the vacuum.

### BACKGROUND

Conventional bag vacuums and cyclone vacuums initially retain small particles and insects in the pre-filter, vacuum bag and/or cyclone filter. The disadvantage thereof is that insects and spiders may crawl out of or die in the vacuum and/or the vacuum bag or cyclone filter. The insects and spiders are also often injured or killed by the impact with internal components of the vacuum. The bodily fluids of insects and spiders released during this process cause additional microbial contamination due to decomposition processes, for example, in the pre-filter, vacuum bag or cyclone filter.

Various devices for vacuums are available to capture insects to be removed and to release them back into the wild rather than killing them. DE 10 2013 018 532 A1 describes a vacuum attachment for capturing live insects with a suction nozzle, wherein the suction nozzle serves as a collection container and has a screen for retaining the insects and/or small parts across the entire cross-section of the suction nozzle at right angles to the suction direction. In the suction direction downstream of the screen, the suction nozzle is connected to a suction tube, which can in turn be connected to a vacuum tube of a commercially available trunk vacuum cleaner using an adapter or sealing rings. The disadvantage thereof is that insects can hit the screen directly in the suction air flow, get their legs caught in the screen mesh, or even be killed.

DE 9110052 U1 describes an approximately one meter long, transparent additional tube for hand and floor vacuums for extracting and trapping insects which opens at the end in the shape of a funnel and which can be plugged onto the telescopic tube of a vacuum, wherein an intermediate piece can be plugged onto one plug-in side of the additional tube, which contains a grid-shaped screen for retaining the insects. The screen is also arranged at right angles to the air flow in the intermediate piece.

EP 1 040 756 A1 describes an insect catching attachment for a vacuum which has a collection container with a filter medium which is also arranged transversely to the air flow, wherein a movable valve is connected upstream which is opened when a vacuum suction pressure is present in the collection container.

DE 18 09 771 U describes a funnel-shaped device for catching flying insects which can be attached to the fan of a vacuum. A screen box is attached inside the funnel-shaped device which can be closed with a second screen in the form of a hinged lid inside the funnel-shaped device after the insects have been caught.

Insect trapping devices are also known as separately designed devices. U.S. Pat. No. 6,226,919 B1, for example, describes an insect vacuum trap with an elongated housing and a vacuum-generating centrifugal impeller, wherein a net basket for catching insects is arranged inside the housing and pellets containing paradichlorobenzene for disorientating the insects sucked in are arranged in the net basket.

DE 10 2005 030 502 A1 describes an independent insect catching device with a funnel-shaped inlet opening, a downstream catching tube, and a catching device, wherein a propellant nozzle is arranged coaxially in the catching tube for injecting a gaseous propellant medium into the catching tube. The catching device is made of a soft or hard material and is permeable to gas.

DE 20 2004 006 039 U1 describes an insect vacuum for catching insects which has two parts that can be connected to one another, wherein the first part has a suction motor and a removable, washable foam filter, wherein the foam filter is arranged directly upstream of the suction motor, and the second part has a transparent catching container with a suction opening.

U.S. Pat. No. 4,074,458 A describes a portable motorized hand-held suction device for catching flying insects, in the housing of which an inner chamber which is open towards the inside of the nozzle is arranged to accommodate a removable mesh cage.

WO 96/26641 A1 describes a suction apparatus and a hand-held vacuum for capturing insects without injuring them, wherein a suction mouth in the form of a tube has a hair filter. The hairs of the hair filter extend radially and longitudinally into the suction mouth, thereby holding insects in place and preventing them from re-emerging from the suction mouth.

The disadvantage of all known devices in which the insects or spiders impact directly on the screen basket or the screen net is that, in addition to possible injury from the impact itself, there is always the risk that the legs of the insects or spiders will be pulled through the screen openings due to the suction vacuum of the vacuum. The legs break off easily and/or the insects/spiders are injured on the body by being crushed on the edge of the screen opening. The fact that the insect body remains on one side of the screen surface while the legs are pulled through to the other side of the screen surface also makes it more difficult to release the insect or spider without injury.

### SUMMARY

An aspect of the present invention is to improve on the prior art.

In an embodiment, the present invention provides a vacuum attachment for a vacuum tube of a vacuum for a non-destructive screening of at least one of an object and a living creature. The vacuum attachment includes a suction tube, a collection unit, and an adapter unit. The suction tube has a first end and a second end. The first end is arranged opposite to the second end. A suction opening is arranged at the first end. The collection unit for the non-destructive screening is arranged in the suction tube downstream of the suction opening in a suction direction. The collection unit comprises at least one opening for a flow of a suction air stream, and an air-permeable impact protection material arranged upstream of the at least one opening in the suction direction. The adapter unit is arranged at the second end of the suction tube. The adapter unit is configured to connect to the vacuum tube of the vacuum.

### BRIEF DESCRIPTION OF THE DRAWINGS

The present invention is described in greater detail below on the basis of embodiments and of the drawings in which:

FIG. 1 shows a highly schematic sectional representation of a vacuum attachment with a screen bottom and a foam insert arranged above the screen bottom in a state with an open lid; and

FIG. 2 shows a highly schematic sectional representation of an alternative vacuum attachment with a screen basket and an inserted foam insert in a state with a suction opening closed by a lid.

### DETAILED DESCRIPTION

The present invention provides a vacuum attachment for a vacuum tube of a vacuum for the non-destructive screening of objects and/or living creatures, wherein the vacuum attachment has a suction tube with a suction opening at a first end, and a collection unit for screening which is arranged in the suction tube downstream of the suction opening in a suction direction, wherein the collection unit has one or more openings for the flow of a suction air stream, and the vacuum attachment has an adapter unit at a second end opposite the first end for connection to the vacuum tube of the vacuum, wherein the collection unit has an air-permeable impact protection material in the suction direction upstream of the opening(s).

The present invention thereby provides a vacuum attachment with a screen function for the sustainable and non-lethal collection of insects or spiders and the non-destructive collection of objects such as game pieces.

It is particularly advantageous that the air-permeable impact protection material is arranged upstream of the opening(s) in the suction direction. This means that the opening(s) for letting the suction air through are covered with the air-permeable impact protection material and a living creature sucked into the vacuum attachment cannot come into direct contact with the screen surface and an opening. The legs of the creature cannot therefore be pulled through the opening(s) due to the negative pressure of a connected vacuum. Finely contoured small parts with a small component likewise cannot be sucked into an opening and get stuck therein.

In addition to spatially covering the openings in the suction direction, the air-permeable impact protection material also has a cushioning effect when the living creature and/or object strikes the catching unit, thereby further reducing the risk of injury or damage. This design of the collection unit therefore provides that the collected living creature can be released unharmed from the vacuum attachment, for example, back into nature. The vacuum attachment therefore prevents injury to insects and spiders and/or damage to small parts during vacuuming.

Due to the arrangement of the collection unit downstream of the suction opening, the insects, spiders and/or small parts are also sucked directly into the collection unit and collected there without being transported further into the suction tube and/or vacuum tube of the vacuum. This prevents insects and/or spiders from getting into the pre-filter and/or vacuum bag of a conventional vacuum, where they may either crawl out again or die. It is also difficult to find small parts, such as a puzzle piece, among the dirt in the standard vacuum bag without exposure to increased dirt and dust when searching therethrough.

As the living creatures and/or small parts are screened out via the collection unit in close proximity to the suction opening of the vacuum attachment, they can also be released and/or tipped out of the vacuum attachment directly and quickly.

A core idea of the present invention is based on providing a cushioning of the impact of the living creatures and/or small parts, at least in the area in which the living creatures and/or small parts hit the surface of the collection unit during suction, via a flat lining of the collection unit with the air-permeable impact protection material and at the same time preventing direct contact of the living creatures and/or small parts by covering the screen surface with the openings. The cushioning effect of the air-permeable impact protection material reduces the impact speed of living creatures and/or small parts, thus providing a vacuum attachment that safely captures and vacuums up insects without injuring them and small parts without destroying them. The fact that the impact protection material is permeable to air in the suction direction upstream of the opening(s) also minimizes the pressure loss through the impact protection material itself, and the operation of a connected vacuum cleaner is not impaired. This makes the vacuum attachment suitable for the targeted vacuuming of living creatures and/or small parts as well as for conventional cleaning of surfaces.

It is particularly advantageous that the insects, spiders and small parts inside the suction tube are held back by the upstream impact protection material and not by the openings. By arranging the air-permeable impact protection material upstream of the openings in the suction direction, the impact protection material simultaneously performs the function of impact absorption and filter element for the insects, spiders and/or small parts to be screened and provides for their retention. This means that the maximum diameter of the subsequent openings in the direction of flow and therefore the separation size need not be adapted to the size of the insects, spiders and/or small parts.

The openings can advantageously also have a larger diameter than the insects, spiders and/or small parts to be vacuumed up, as they are not retained by the dimensions of the openings, but by the upstream air-permeable impact protection material. The fact that a considerably larger diameter than the maximum diameter of the insect, spider or small part can be selected for the openings minimizes the pressure loss through the catching unit and the pressure loss caused by the upstream air-permeable impact protection material itself can be compensated for by a correspondingly large design of the openings.

The following terms are explained:

A “vacuum attachment” is in particular a component that can be connected to a vacuum tube of a conventional vacuum via an adapter unit of the vacuum attachment. A vacuum attachment is, for example, connected to the vacuum tube of a vacuum instead of a brush head. When connected, the sucked-in air first enters the vacuum attachment and then the connected vacuum tube of the vacuum. The vacuum attachment is in particular tubular with a suction tube, wherein the suction tube has the suction opening for vacuuming up living creatures, objects and/or dust and the downstream collection unit for collecting and thus screening the living creatures and/or objects. The vacuum attachment and its components, including the collection unit, can in principle be made of any material, such as plastic, metal and/or a composite material. The vacuum attachment can also have a bio-based plastic, such as one based on wood, bamboo, oilseeds and/or other starch-and cellulose-rich plants.

A “suction tube” is in particular a tube that feeds the living creatures and/or objects to the collection unit and/or the vacuum tube of a vacuum with the suction air flow containing dust and other small dirt particles. A suction tube can also be a suction hose. The suction tube can, for example, have the suction opening at one end and the adapter unit for connecting to the vacuum tube of a vacuum at the opposite end.

The “suction opening” of the vacuum attachment is in particular an opening on the suction side of the suction tube of the vacuum attachment. The suction opening can, for example, have the inside diameter of the suction tube or the inside diameter of the collection unit. The suction opening of the vacuum attachment is guided by the user over the insect, spider, objects to be removed and/or the surface to be cleaned.

The “suction direction” is in particular the direction in which the air is sucked from the suction opening of the suction tube of the vacuum attachment through the adapter unit and, in the case of a connection, further through the vacuum tube into the vacuum and thus forced to move.

A “collection unit” is in particular a component that is used to classify and separate and thus screen living organisms and/or objects from the suction air flow. For the separation and thus the retention of living creatures and/or objects, the collection unit in particular has a surface or partial surface with one or more openings through which the suction air flow with the non-retained dust and other dirt particles passes. In its simplest embodiment, the collecting unit can be designed as a screen bottom or as a screen basket. The collection unit in particular has the air-permeable impact protection material at least in the area where the insects and/or objects hit the collection unit.

An “opening” is in particular a hole or slot in a surface of the collection unit. The opening in particular has a minimum diameter or dimension, whereby the separation size of the collection unit is defined as a screen, in particular for dust and/or dirt particles and not for the insects and/or objects already previously screened out by the impact protection material. When the vacuum attachment is connected to the vacuum tube of a vacuum cleaner, the suction air flow is in particular sucked through the opening(s) of the collection unit during suction, thereby providing a necessary vacuum for sucking in the living creatures and/or objects at the suction opening.

An “impact protection material” is in particular a cushioning, compressible and/or elastic material. The impact protection material in particular covers an opening or several openings of the collection unit on the side of the collection unit aligned with the suction opening. In particular, “air-permeable” means that the impact protection material is porous and thus has air-filled cavities. The air-filled cavities of the impact protection material are in particular continuous so that air drawn in at the suction opening of the vacuum attachment passes through the air-permeable impact protection material and is conveyed further through the suction rube in the suction direction to the vacuum. The impact protection material can be fixed or detachable upstream of the opening(s) on the collection unit. The impact protection material can, for example, be bonded to the collection unit. The impact protection material can also be connected to the collection unit in a form-fitting and therefore detachable manner, for example, using a Velcro fastener. Instead of a connection on the collection unit itself, the impact protection material can, however, also be connected inside the vacuum attachment. The impact protection material can, for example, be attached directly to the inside of the suction opening of the suction tube via a clamp connection. It is also possible to dispense with a connection between the impact protection material and the collection unit and/or the vacuum attachment, with the air-permeable impact protection material only being insertable on the collection unit upstream of the opening(s) in the suction direction. Due to the suction pressure in the suction direction, the air-permeable impact protection material is automatically sucked in in the suction direction itself and is thus held upstream of the opening(s) on the collection unit. The underside of the impact protection material can lie directly against the opening(s) in the intake direction or be spaced apart by an air volume and/or carrier material, for example, a coarse mesh screen, upstream of the opening(s) in the suction direction.

The “vacuum tube” of a vacuum is in particular the tube through which the suction air, dust and dirt enter the interior of the vacuum. A vacuum hose can be arranged between the vacuum tube and the housing of the vacuum. A vacuum hose can, however, also replace a vacuum tube so that the vacuum hose of the vacuum can be connected directly to the vacuum attachment according to the present invention.

A “vacuum” can be any commercially available vacuum cleaner. A vacuum is in particular a cleaning device which is equipped with a blower, wherein the blower generates a vacuum to suck in suction air, dust and/or dirt. A vacuum can, for example, be a bag vacuum, a cyclone vacuum, an industrial vacuum, and/or a vacuum with a water filter. The vacuum attachment can in principle also be used for a table vacuum cleaner or leaf vacuum.

In a further embodiment of the vacuum attachment, the air-permeable impact protection material has a foam and/or a fiber structure.

This means that the cavity volume and the damping properties of the impact protection material can be specifically adjusted via the production of the foam and/or the fiber structure.

In particular, “foam” is understood to mean an artificially produced material with a cellular structure and low density. Foam is in particular compressible so that pressure causes a reduction in volume. A foam is in particular an open-cell foam in which the cell walls are not closed so that a continuous cavity system exists for air to pass through. Foam in particular includes plastic, for example, polypropylene, polyethylene, polystyrene, PET and/or a biopolymer.

A “fiber structure” (also called “nonwoven”) is in particular a structure made of fibers of limited length, continuous fibers, and/or cut yarn of any kind, which are joined together and bonded to form a fiber layer. The fibers can be natural and/or artificial fibers. A fiber structure is in particular a flexible textile fiber structure that is easily bendable and which can, for example, have a low thickness compared to its length and width. Instead of or in addition to textile fibers, however, the fiber structure can also have paper, plastic, and/or fiber-reinforced plastic fibers. The fiber structure is also in particular permeable to air.

In order to achieve low air resistance and low pressure loss, the air-permeable impact protection material has a porosity in a range from 10% to 99%, in particular from 30% to 95%, for example, from 50% to 90%.

Optimum porosity and thus air permeability allow dust particles and other dirt particles to pass through the air-permeable impact protection material in the suction direction via the additional suction tube and the adapter unit of the vacuum attachment into the vacuum tube of the connected vacuum, where they can be separated. The suction power of the vacuum is not or only slightly impaired by the air-permeable impact protection material. The porosity and thus the cavity volume can also be used to adjust the damping properties and compressibility of the impact protection material.

In particular, “porosity” is a dimensionless measured variable that indicates the ratio of the cavity volume to the total volume of the impact protection material. The porosity is in particular also the total porosity, which is the sum of the open porosity, which comprises the cavities that are connected to each other and to the environment, and the closed porosity, in which the cavities are not connected to each other.

In a further embodiment of the vacuum attachment, the air-permeable impact protection material can, for example, have a material thickness in the range from 1.0 mm to 50.0 mm, in particular from 3.0 mm to 30.0 mm, for example, from 5.0 mm to 20.0 mm.

The “material thickness” is in particular the dimension of the air-permeable impact protection material in the direction transverse to the largest longitudinal dimension of the impact protection material and thus to its length and width. The material thickness of the impact protection material can essentially be the longitudinal dimension parallel to the suction direction and/or parallel to the passage direction of the opening(s).

The collection unit has a screen disc to provide that air can flow through the openings directly in the suction direction, wherein the screen disc is arranged substantially transverse to the suction direction in the suction tube.

The outer diameter of the screen disc can, for example, cover the entire inner diameter of the suction tube. The openings passing through the screen disc can be distributed evenly or unevenly over the entire surface of the screen disc or only in a partial area of the screen surface. If, for example, only a central area of the screen disc around the longitudinal center axis of the suction tube is formed with the openings, the outer edge areas that are not flowed through have a flow-calmed area into which the insect or spider that has been vacuumed up can crawl and there recover. The entire surface of the screen disc, which is aligned with the suction opening, is in this case covered with the air-permeable impact protection material and thus also in the areas of the screen disc that are free of openings.

A “screen disc” is in particular a disc-shaped filter that works on the principle of a screen. The screen disc in particular has one or more openings through its thickness. The screen disc can, for example, be arranged downstream of the suction opening at a distance from it essentially transverse to the suction direction in the suction tube in order to form a collection chamber of the collection unit. The term “substantially transverse” means that the longitudinal dimension of the screen disc and thus its diameter need not necessarily be aligned at an angle of 90° to the suction direction and thus to the longitudinal center axis of the suction tube. The screen disc can, for example, also be installed at an angle inside the suction tube. The screen disc need not necessarily be a flat circular disc; the screen disc can, for example, also be curved in the suction direction or against the suction direction.

In a further embodiment of the vacuum attachment, the collection unit can, for example, have a screen basket, wherein the screen basket has an opening in a direction towards the suction opening, a side element adjoining the opening, and a screen bottom opposite the opening.

Due to the design as a screen basket, the openings can be made in both the side element and the screen bottom. The screen container itself can also be designed in one piece with a screen bottom firmly attached to the side element or in several parts. One part of the screen basket can, for example, have the opening with the side element adjoining in the suction direction and be screwed onto a subsequent second part with the screen bottom or connected with a snap-in connection. Removal and cleaning of the screen basket is made easier by the fact that the screen basket can be detached inside the suction tube at the suction opening and/or the screen basket can be dismantled between the side element in the suction direction and the screen bottom.

A “screen basket” is in particular a basket-shaped filter element. The screen basket in particular has one and/or more openings in its side element and/or screen bottom. The screen basket in particular has an opening opposite its screen bottom for the suction air to flow into the screen basket and subsequently through the openings in the screen basket. The inside of the screen basket can, for example, be completely covered with the air-permeable impact protection material.

A “side element” is in particular one or more side walls of the screen basket. With the exception of the screen bottom, the screen basket can, for example, be tubular in the suction direction so that it has a circumferential side wall. The basic geometric shape of the screen basket can of course also be designed as an elongated cuboid and even have four square, rectangular side walls parallel to the suction direction. The screen basket can also have a triangular or polygonal cross-section. The screen basket can, for example, have a round cross-section at the suction opening of the suction tube. The round screen basket can, for example, be inserted, snapped in or firmly connected with its outer diameter around its opening inside the suction tube in the area of the suction opening.

The “screen bottom” is in particular a structural element that limits the screen basket in the suction direction. A screen bottom can also be a screen disc and/or a perforated plate. The screen bottom can, for example, have several openings. The screen bottom can, however, also be designed as a closed bottom which is free of openings. The suction air in this case only flows through the openings in the side element of the screen basket.

In order to optimally integrate and/or connect the screen basket flush with the suction opening of the suction in the area of its opening, the side element of the screen basket is radially circumferential and/or tapered in the suction direction.

The screen basket therefore has a radially circumferential side wall and a round cross-section.

In the event that the screen basket tapers conically in the suction direction towards the screen bottom, the screen surface formed by the openings in the side element increases in the transverse direction to the suction direction. The passage of the suction air flow, which enters the collection unit directly through the suction opening of the suction tube and the opening of the screen basket, is consequently further improved by the openings in the side element in the suction direction. The suction flow exiting through the side walls thus flows further in the outer area of the hollow space of the suction tube in the intake direction, also around the screen bottom of the screen basket inside the suction tube in the direction of the adapter unit. Because the screen basket has the shape of a truncated cone in the suction direction, and the screen bottom therefore has a smaller diameter than the opening of the screen basket, the screen basket can more easily be removed from the suction tube. In the case of a closed screen bottom, the conical shape of the collection unit can furthermore create a flow-calmed area above the closed screen bottom or one with only a few openings, thus further preventing injury to living creatures and/or destruction of objects in addition to the impact protection material.

In a further embodiment of the vacuum attachment, the impact protection material can, for example, be arranged upstream of the side element and/or the screen bottom in the suction direction.

This means that only the side element or the screen bottom can be covered with the impact protection material or the screen basket with side element and screen bottom is completely covered with the impact protection material. It is particularly advantageous if the inside of the screen basket is completely lined in one piece with the impact protection material, wherein the one-piece impact protection material is formed with a shape corresponding to the shape of the screen basket. This means that the one-piece impact protection material can be easily removed from the opening of the screen basket and cleaned or replaced.

The suction tube has a constant cross-section to provide an even flow.

The constant cross-section does need not, however, be formed over the entire length of the suction tube. The suction tube can, for example, have a constant cross-section in the area of the adapter unit and widen conically in the direction of the suction opening to make it easier to suck up insects and/or small parts with a larger suction opening. This results in a conical constriction of the suction tube in the opposite suction direction, whereby the insects and/or small parts sucked up are guided to the collection unit in a targeted manner. The suction opening can conversely also have a smaller cross-section than the suction tube. The entire vacuum attachment with the suction tube and the adapter unit can also have a conically widening and/or narrowing shape over its length.

In a further embodiment of the vacuum attachment, the adapter unit can, for example, be tapered in the suction direction so that suction tubes with different internal diameters can be fitted onto the adapter unit.

As the adapter unit narrows conically in the suction direction, the opening of a vacuum tube of a conventional vacuum can be pushed directly onto the adapter unit against the suction direction until the adapter unit and the vacuum tube are frictionally connected. There is consequently no need for separate additional connecting parts and/or sealing material. It is particularly advantageous that the tapered adapter unit can be inserted into all standard inner diameters of vacuum tubes. The adapter unit can in principle also expand conically in the suction direction so that in this case, the adapter unit is inserted from the outside via the vacuum tube in the suction direction until the adapter unit and the vacuum tube are frictionally connected.

In order to dispense with a connection and/or sealing material, the suction tube and the adapter unit downstream in the suction direction are formed in one piece.

The suction tube with a constant diameter can, for example, merge seamlessly into the adapter unit with a tapered diameter in the suction direction.

This means that the user must only handle the vacuum attachment as a single part and insert it into a conventional vacuum tube to suck up insects, spiders and/or objects. Handling is thereby significantly simplified and vacuum loss due to leaks is avoided.

In a further embodiment, the vacuum attachment can, for example, have a lid that can be opened and closed for opening and closing the suction opening.

This means that after sucking up and catching an insect inside the collection unit, the suction opening of the suction tube of the vacuum attachment and thus the opening of the collection unit can be closed immediately, thus preventing the insect from crawling or flying out of the suction opening. Contact or proximity to the insect or spider can thereby be avoided, in particular for allergy sufferers and those afraid of insects and/or spiders,.

It is particularly advantageous if the lid, which is opened during use of the vacuum attachment, closes almost automatically without manual intervention after the insect has been sucked in and collected in the collection unit. The lid can, for example, be attached to the outside of the suction tube via a spring mechanism so that the lid closes automatically, for example, when the outside of the lid touches the bottom.

In order to maximize the distance to the lid for those afraid of insects and allergy sufferers, such as those allergic to bee venom, the lid has a lateral projection above an outer diameter of the suction tube so that the projection can be pressed against with an elongated object in order to open the lid.

This means that even those who are squeamish and/or allergy sufferers can release a trapped insect independently and without any problems without having to get too close to the suction opening. After the user has taken the vacuum attachment outside or placed it on the outside of a windowsill, for example, the user simply presses against the lateral projection of the lid, for example, with a long stick parallel to the suction tube and against the suction direction, thereby causing the lid to again open.

In a further embodiment, the lid can, for example, have holes for the suction air flow to pass through.

This means that suction can continue with the lid closed even after an insect or spider has been sucked into the collection unit. The holes in the lid prevent a vacuum in the vacuum attachment during continued suction operation and provide that the insect or spider picked up remains on the impact protection material of the collection unit. It can thereby be provided that the insect or spider does not move inside the collection unit towards the lid due to the continued suction operation when the lid is closed and is immediately in the area of the suction opening when the lid is opened. This provides for a safe, injury-free release of the insect or spider when opening the lid and interrupting the suction operation, while people who are squeamish can assume that the insect or spider will not exit the suction opening immediately after opening the lid for release, but must first move from the bottom to the attachment opening or first fall out when the vacuum attachment is shaken.

The vacuum attachment can also have a regulator for adjusting the suction power. This allows the suction force to be adapted to the type, size and/or vulnerability of the insect and/or object to be sucked in.

A “regulator” can, for example, be a slider or rotary control for adjusting the air flow rate, as is often the case with commercially available vacuums on the handle.

An additional aspect of the present invention provides a vacuum having a vacuum attachment as described above.

The present invention is explained in greater detail below with reference to exemplary embodiments as shown in the drawings.

A vacuum attachment 101 has a suction tube 103, which has a suction opening 105 on one suction side. The suction tube 103 has a constant cross-section in a suction direction 123. At one end opposite the suction opening 105, the suction tube 103 merges seamlessly into an adapter unit 121, which is here provided as an adapter cone 121. A collection unit 107 is arranged inside the suction tube 103 at a distance from the suction opening 105. The collection unit 107 has a screen disc 113 with several screen holes 117 over the entire inner cross-section of the suction tube 103. An air-permeable foam insert 119 of the collection unit 107 is arranged above the screen disc 113 in the direction of the suction opening 105. The air-permeable foam insert 119 has a material thickness of 10 mm.

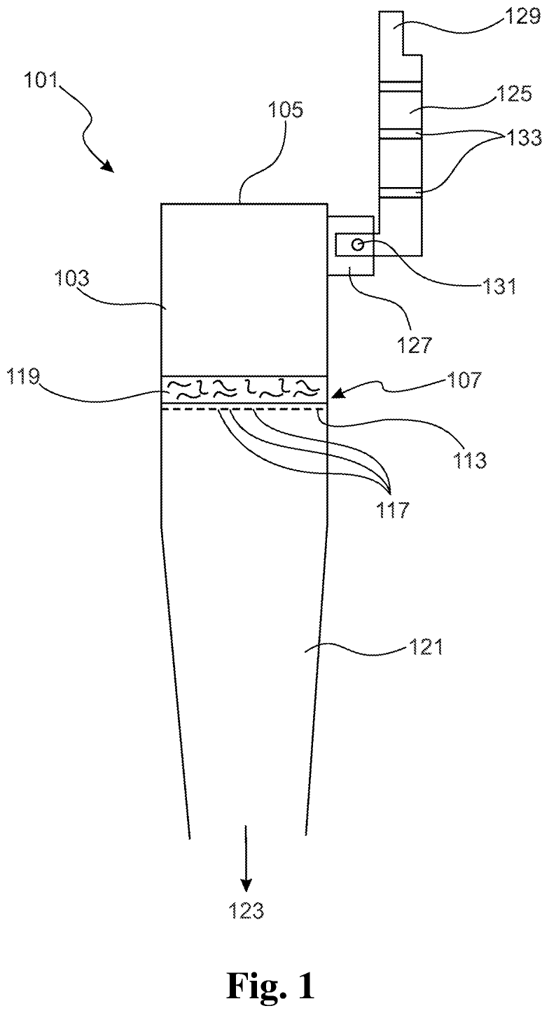

The vacuum attachment 101 has a lid holder 127 on the outside of the suction tube 103 which is connected to a lid 125 via an internal spring 131. The lid 125 has several holes 133. Opposite the lid holder 127, the lid 125 has a lid projection 129 which projects laterally. FIG. 1 shows the vacuum attachment 101 in the state with open, hinged lid 125, exposing the suction opening 105.

The vacuum attachment 101 is used by a person afraid of spiders to vacuum up a spider in the living room. For this purpose, the vacuum attachment 101 is inserted with its adapter cone 121 into a vacuum tube of a bag vacuum (not shown in FIG. 1). The bag vacuum (not shown) is switched on, and suction air is drawn in via the open suction opening 105 in the suction direction 123 through the suction tube 103, the air-permeable foam insert 119, the screen holes 117, and the adapter cone 121. The person afraid of spiders now guides the suction opening 105 over the spider to be sucked up, wherein the person afraid of spiders can maintain a maximum spatial distance from the suction opening 105 due to the vacuum attachment 101 inserted into the vacuum tube of the bag vacuum via the adapter cone 121.

The ambient air drawn in is drawn through the pores of the air-permeable foam insert 119 and through the subsequent screen holes 117 of the screen disc 113 and, after passing through the screen holes 117 in the suction tube 103, is conveyed further in the suction direction 123 through the adapter cone 121. The size of the spider that has been sucked up is significantly larger than the pores of the air-permeable foam insert 119. Conveyed by the suction air flow in the intake direction 123, the spider directly hits the air-permeable foam insert 119 lying transverse to the suction direction 123. Due to the elasticity and compressibility of the air-permeable foam insert 119, the impact of the spider is cushioned, and the spider is retained without injury by the air-permeable foam insert 119 of the collection unit 107 inside the suction tube 103 above the screen disc 113 and thus screened out. Smaller dust and dirt particles in the suction air flow can in contrast pass through the pore system of the air-permeable foam insert 119 and the subsequent screen holes 117 and are conveyed further via the lower part of the suction tube 103 and the adapter cone 121 to the vacuum tube of the bag vacuum (not shown).

The person afraid of spiders then turns the vacuum attachment 101 so that the opened lid 125 hits the floor on the outside, whereby the lid 125 automatically closes due to the internal spring 131 and the spider, which is held back without injury on the air-permeable foam insert 119, is trapped inside the vacuum attachment 101.

The person afraid of spiders then moves the closed vacuum attachment 101 with the connected vacuum tube and the bag vacuum to an open window and holds the vacuum attachment 101 outside into the ambient air. The person afraid of spiders then switches off the bag vacuum cleaner, as a result of which no more ambient air is sucked into the vacuum attachment 101 through the holes 133 in the lid 125, and then presses against the lid projection 129 from below with the tip of a broomstick, causing the lid 125 to swing open and to expose the suction opening 105. The person afraid of spiders now holds the suction opening 105 of the vacuum attachment 101 slightly downwards so that the spider falls outside into the environment.

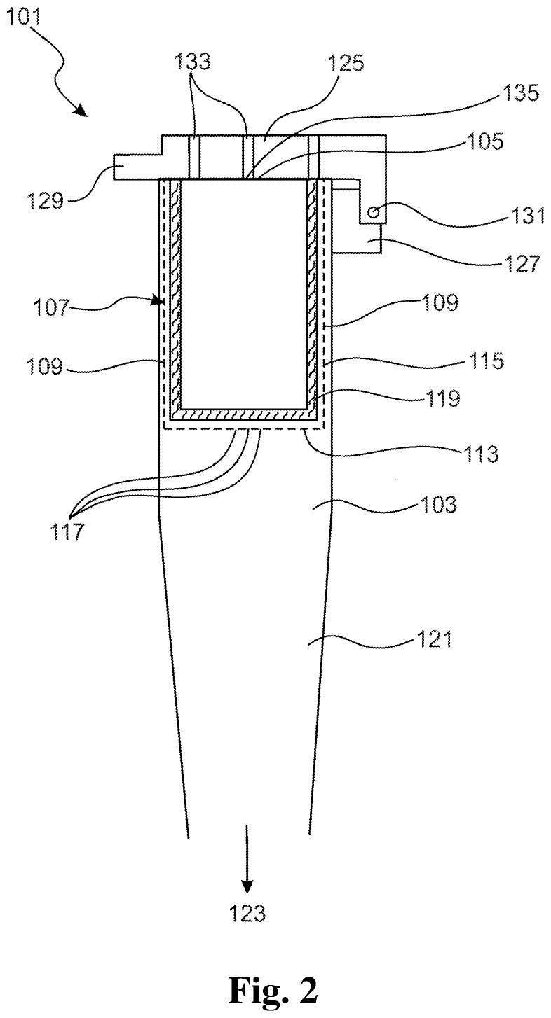

In an alternative to vacuum attachment 101, which is shown in FIG. 2, the vacuum attachment 101 is designed as described above with respect to the lid 125, the suction tube 103, and the adapter cone 121, and is used analogously. In this alternative of the vacuum attachment 101, the collection unit 107 has a screen basket 115 with an upper opening 135, a radially circumferential side wall 109, a screen bottom 113 (instead of a screen disc 113), and screen holes 117 in the radially circumferential side wall 109 and in the screen bottom 113. The screen basket 115 is completely covered with the air-permeable foam insert 119 on the inside of the suction opening 105 and aligned with the upper opening 135 so that the screen holes 117 of the screen basket 115 following in the suction direction 123 are covered by the air-permeable foam insert 119.

FIG. 2 shows this alternative of the vacuum attachment 101 with the lid 125 closed. To use the vacuum attachment 101, the closed lid 125 is accordingly opened manually by the user (and thus moved to the right in FIG. 2), whereby the suction opening 105 opens. The vacuum attachment 101 is then used as described above. The design of the collection unit 107 as a screen basket 115 with the complete covering via the air-permeable foam insert 119 provides a larger retention surface for insects and small parts, and the suction air not only passes through the screen holes 117 in the screen bottom 113 in the suction direction 123, but also through the side screen holes 117 of the circumferential side wall 109. This increases both the suction capacity of the collection unit 107 and the volume of suction air passing through.

A suction attachment 101 is thus provided with which insects and spiders can be sucked in and captured without injury so as to allow their release in a targeted manner, even by those who are afraid of them, at a sufficient distance from the vacuum attachment 101 and its suction opening 105.

The present invention is not limited to embodiments described herein; reference should be had to the appended claims.

### LIST OF REFERENCE NUMERALS

101 Vacuum attachment
103 Suction tube
105 Suction opening
107 Collection unit
109 Circumferential side wall
113 Screen bottom/Screen disc
115 Screen basket
117 Screen holes
119 Air-permeable foam insert
121 Adapter cone/Adaptor unit
123 Suction direction
125 Lid
127 Lid holder
129 Lid projection/Lateral projection
131 Internal spring
133 Holes
135 Upper opening/Opening

What is claimed is:

1-14. (canceled)

15. A vacuum attachment for a vacuum tube of a vacuum for a non-destructive screening of at least one of an object and a living creature, the vacuum attachment comprising:
a suction tube having a first end and a second end, the first end being arranged opposite to the second end, a suction opening being arranged at the first end;
a collection unit for the non-destructive screening arranged in the suction tube downstream of the suction opening in a suction direction, the collection unit comprising at least one opening for a flow of a suction air stream, and an air-permeable impact protection material arranged upstream of the at least one opening in the suction direction; and
an adapter unit arranged at the second end of the suction tube, the adapter unit being configured to connect to the vacuum tube of the vacuum.

16. The vacuum attachment as recited in claim 15, wherein the air-permeable impact protection material has at least one of a foam structure and a fiber structure.

17. The vacuum attachment as recited in claim 15, wherein the air-permeable impact protection material has a porosity of from 10% to 99%.

18. The vacuum attachment as recited in claim 15, wherein the air-permeable impact protection material has a material thickness of from 1.0 mm to 50.0 mm.

19. The vacuum attachment as recited in claim 15, wherein the collection unit further comprises a screen disc which is arranged substantially transverse to the suction direction in the suction tube.

20. The vacuum attachment as recited in claim 15, wherein,
the collection unit further comprises a screen basket, and
the screen basket comprises an opening in a direction towards the suction opening, a side wall which adjoins the opening, and a screen bottom which is arranged opposite to the opening.

21. The vacuum attachment as recited in claim 20, wherein the side wall of the screen basket is arranged to be at least one of radially circumferential and tapered in the suction direction.

22. The vacuum attachment as recited in claim 20, wherein the impact protection material is arranged upstream of at least one of the side wall and of the screen bottom in the suction direction.

23. The vacuum attachment as recited in claim 15, wherein the suction tube has a cross-section which is constant.

24. The vacuum attachment as recited in claim 15, wherein the adapter unit is tapered in the suction direction so that suction tubes with different internal diameters can be fitted thereon.

25. The vacuum attachment as recited in claim 15, wherein the suction tube and the adapter unit are formed integrally.

26. The vacuum attachment as recited in claim 15, wherein the vacuum attachment further comprises:
a lid which is configured to be opened and closed so as to open and close the suction opening.

27. The vacuum attachment as recited in claim 26, wherein the lid comprises a lateral projection which extends over an outer diameter of the suction tube so that an elongated object can press against the lateral projection to thereby open the lid.

28. The vacuum attachment as recited in claim 26, wherein the lid comprises holes for the flow of the suction air stream.
